(19) United States
(12) Patent Application Publication
(10) Pub. No.: US 2004/0078994 A1
(43) Pub. Date: Apr. 29, 2004

(54) Dryer

(75) Inventor: Jean-Marc Vandoorne-Feys, Wilrijk (BE)

Correspondence Address: WOOD, HERRON & EVANS, L.L.P., 2700 Carew Tower, 441 Vine St., Cincinnati, OH, 45202, US

(73) Assignee: IPSO-LSG

(21) Appl. No.: 10/649,428

(22) Filed: Aug. 27, 2003

(30) Foreign Application Priority Data
Sep. 29, 2002 (BE) 2002/0561

(51) Int. Cl. F26B 11/02

(52) U.S. Cl. 34/595

(57) ABSTRACT

A dryer, in particular a dryer (1) to dry linen and the like, with a drying drum (2), drive means (4) to rotate the drying drum (2), means (5) to create an air flow (6), in particular a hot air flow (6), and air conduction means (7) to lead the air flow (6) through the drying drum (2), characterized in that the air conduction means (7) have been thus conceived that the air flow (6) is mainly forced to enter the drying drum (2) from an inlet, before being discharged via an outlet, whereby the air thereby is also forced to enter the drying drum (2) via one or more air passage openings (19-26) which are located at the cylindrical casing part (20) of the drying drum (2) and/or at one axial end (22) of the drying drum (2), but near the outer circumference thereof.

### BACKGROUND OF THE INVENTION

1. Field of the Invention

The present invention concerns a dryer, in particular a dryer to dry linen and the like.

In particular it concerns a dryer of a type containing a drying drum, drive means to rotate the dryer, means to create an air flow, and air conduction means to lead the air flow through the dryer.

2. Discussion of the Related Art

Dryers of this kind are already known in various forms. They differ from each other in the way in which the air conduction means are carried out, in particular the way in which these air conduction means supply the air to and discharge the air from the drying drum.

Thus for example dryers are known whereby the drying drum is provided with air conduction holes along the complete surface of the cylindrical casing part, and whereby this drying drum is fitted in a fixed outside drum, so that around the complete cylindrical casing part of the drying drum there is a continuous interspace in between the fixed drum and the dryer. The air is thereby led in the interspace via an air inlet channel near one end and discharged near the other end via an air outlet channel, so that the air in between can penetrate the drying drum from the interspace and via the above-mentioned air conduction holes to dry the linen. Such an invention has the disadvantage that a part of the air flows directly from the air inlet channel via the interspace to the air outlet channel, without entering the drying drum, as a result of which this part of the air flow contributes less efficiently to the drying of the linen. But this part of the air flow contributes to the heating of the drying drum and thus indirectly to the heating and drying of the linen, however it does not contribute to the direct drying as it does not come into contact with the linen.

Also known are dryers whereby the air is led to the drying drum via a central hole in the back wall of the drying drum, while it is being discharged at the front. Although the linen moves through the drying drum while this is working, such embodiment has the disadvantage that a relatively large part of the air still moves freely through the drying drum without really coming into contact with the linen, and hence the output is not optimal.

### SUMMARY OF THE INVENTION

The present invention concerns a dryer whereby the drying air is being used in a more optimal way compared with the above-mentioned known embodiments, by applying air conduction means which lead the air in an optimal way through the drying drum.

To this end, the invention concerns a dryer, more in particular a dryer to dry linen and the like, with a drying drum, drive means to rotate the drying drum, means to create an air flow, in particular a hot air flow, and air conduction means to lead the air flow through the drying drum, characterized in that the air conduction means have thus been conceived that the air flow is mainly forced to enter the drum from an inlet, before being discharged via an outlet, whereby this air is also forced to enter the drying drum via one or more air conduction holes located in the cylindrical casing part of the drying drum and/or on the axial end of the drying drum, but near its outside circumference.

Hereby thus combining two effects.

On the one hand, the air flow is forced to enter the drum from an inlet, before being discharged via an oulet, meaning that all air, with the possible exclusion of a slight leakage flow, is forced to flow through the drum and hence a direct flow from the inlet to the outlet, outside the drying drum, is excluded, with the exclusion of a slight leakage flow if any.

On the other hand, the air is as above-mentioned further forced to enter the drying drum via one or more air conduction holes which are located on the cylindrical casing part of the drying drum and/or at one axial end of the drying drum, but near the outside circumference thereof, which means that a central air inlet in the back wall is avoided and all air in the drying drum is being forced to places in or near the cylindrical casing part surface, as a result of which an inefficient direct air passage is excluded. By leading the air in this way in the drying drum, there is every chance that it already comes into contact with the linen against the inner wall when penetrating the drying drum. Even when there is no direct contact with the linen when penetrating, there is a notable increase in output because the above-mentioned way of air inlet automatically creates an efficient air movement in the drying drum, this contrary to the air movement resulting from a simple central air inlet in the back wall.

In short, it can be said that the hot air is more efficiently used to dry the linen.

In what way the air conduction means have to be specifically conceived in order to obtain the air flow according to the invention, can easily be deduced by a specialist from the foregoing. In essence, all air channels and wall parts that border the air flow have been thus conceived, in other words are located in such places, that the air can only flow through the drying drum in the above-mentioned way.

In order to further optimize the efficiency of the air flow, it is preferred that all air conduction holes to bring the air in the drying drum are located on the cylindrical casing part of the drying drum. Better still, to this end they are located in one and the same half of the drying drum, for example in the rear half.

According to a specifically preferred characteristic, the air conduction holes which are located on the cylindrical casing part of the drying drum, are located in a zone near one end of the drying drum which stretches as a band around the cylindrical casing part. More in particular, it is preferred that all air conduction holes to bring air to the drying drum are mainly located in such a band-like zone of the cylindrical casing part. This zone has a width smaller than half the axial length of the drying drum and, better still, is limited to less than one fourth of the above-mentioned axial length. In this way, the air is forced to enter the drying drum from directly near the end of the drying drum.

For practical reasons it is preferred that the air conduction holes for the air inlet are located in the rear half of the drying drum.

The above-mentioned air conduction means contain preferably at least one air inlet channel to lead the air in the drying drum, as well as at least one air outlet channel to discharge the air from the drying drum, whereby on the one hand, the air inlet channel and the air outlet channel are thus placed, and on the other hand the drying drum is provided with air conduction holes, that the air flow is generally forced to move from one end of the drying drum to the other end. This does not necessarily mean that the air flow needs to be drawn in, respectively discharged, along the axial ends, but that the overall flow direction of the air as a whole goes from one end to the other. Combined with the above-mentioned, and the characteristics mentioned hereinafter, this contributes to a regular and hence efficient drying.

Discharge of the drying air from the drying drum can be done in various ways according to the invention. The air conduction means preferably comprise one or more air conduction holes to discharge the air from the drying drum, which are located at the cylindrical casing part of the drying drum and/or at one axial end of the drying drum, in particular the axial end located opposite the end from where the air is led into the drying drum.

In the most preferred embodiment however all air conduction holes to discharge the air from the drying drum are located in the cylindrical casing part. More in particular these air conduction holes are located mainly in one and the same half of the drying drum, namely the half pointing to the axial end opposite the axial end from which the air is led into the drying drum.

It is in particular preferred that the air conduction holes to discharge the air which are located on the cylindrical casing part of the drying drum, are located in a zone near one end of the drying drum and stretching as a band along the cylindrical casing part, the same as for the above-mentioned band that has been described above in relation to the air conduction holes used to draw in the air. In the most preferred embodiment even all air conduction holes to discharge the air will be located on this band.

It is observed that the use of air conduction holes in the drying drum, which are located in the band-like zones, are also an advantage in other embodiments of dryers, even when not all the air is forced into the drying drum. Indeed, it has been determined that the inlet of air in the drying drum, respectively the discharge thereof from the drying drum, via respective band-like zones creates an optimal flow and circulation of the air in the drying drum. Taking this into account, the invention also concerns a dryer, more in particular a dryer to dry linen and the like, with a drying drum, drive means to rotate the drying drum, means to create an air flow, more in particular a hot air flow, and air conduction means to lead the air flow through the drying drum, characterized in that the drying drum is provided with two sets of air conduction holes, respectively a first set for the air inlet and a second set for the air outlet, each located at one end of the drying drum in the cylindrical casing part and each stretching as a band around the cylindrical casing part, whereby the part of the cylindrical casing part in between the above-mentioned two sets is generally closed.

### BRIEF DESCRIPTION OF THE DRAWNINGS

In order to better explain the characteristics of the invention, a few embodiments are hereinafter described as an example without being limitative in any way, with reference to the accompanying drawings, in which:

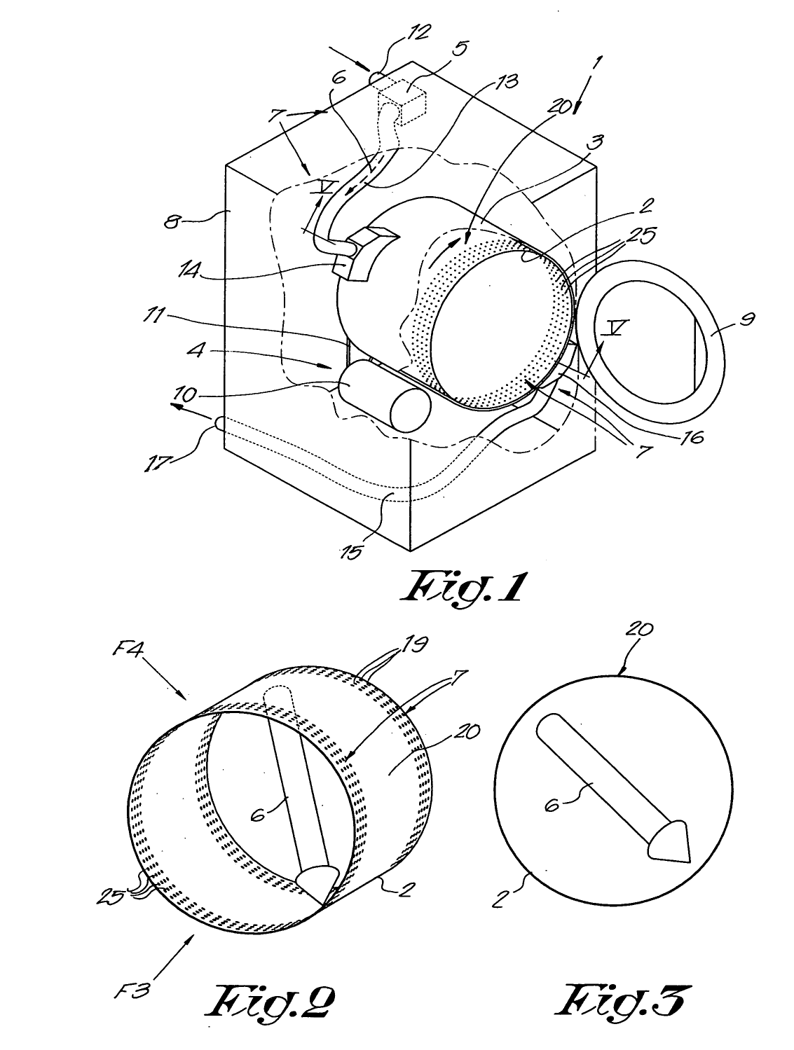

FIG. 1 schematically represents a dryer according to the invention;

FIG. 2 schematically and in perspective represents the drying drum from the dryer of FIG. 1;

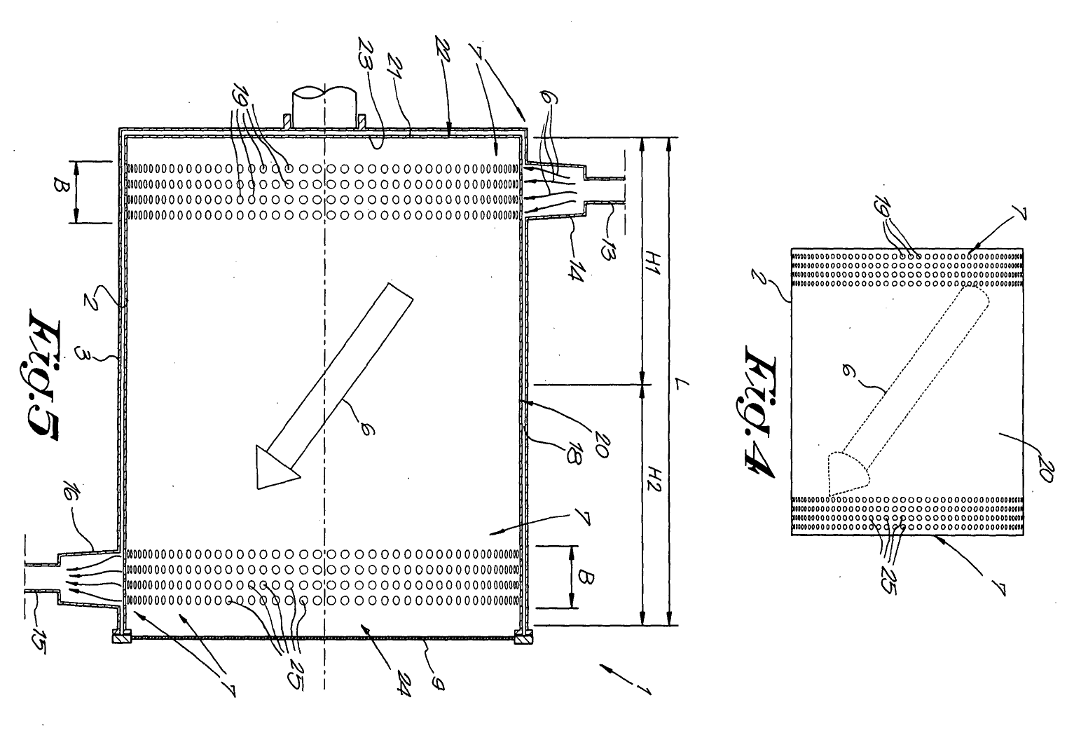

FIG. 3 and 4 represent views respectively according to arrows F3 and F4 in FIG. 2;

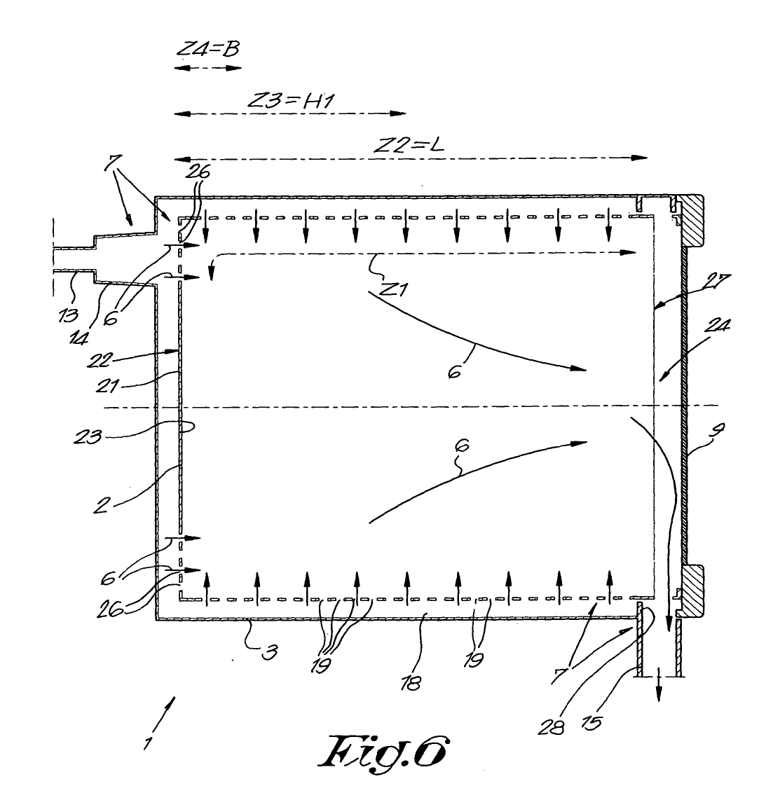

FIG. 5 represents a section on a larger scale according to arrow F5 in FIG. 1;

FIG. 6 represents a section similar to the one of FIG. 5, but for a variant of the invention.

### DESCRIPTION OF THE PREFERED EMBODIMENT

As represented in the FIGS. 1 to 5, the invention concerns a dryer 1 with a rotary drying drum 2 which is in this case surrounded by a fixed drum 3, drive means 4 to rotate the drying drum 2, means 5 to create the hot air flow 6, and air conduction means 7 to lead the air flow 6 through the drying drum 2 and to discharge it subsequently. The assembly is in the usual way built-in in a casing part 8 provided with a door 9 via which the linen is put into the drying drum 2 and afterwards can be removed from it.

The drive means 4 consist of an electrical engine 10 and a transmission 11 to transmit the rotation of the engine axle to the drying drum 2.

The means 5, which are only schematically indicated, can in the traditional way consist of an electrical heating and an air pump or ventilation unit to draw in air via a suction channel and to heat it.

The air conduction means 7 are formed by the assembly of channels, passages, etc. to lead the heated air to the drying drum 2, to lead it therethrough and then to discharge it. These air conduction means 7 contain among others an air inlet channel 13 which is connected via a mouthpiece 14 to the drum 3 and an air outlet channel 15 which from a mouthpiece 16 in the wall of the drum 3 makes a connection for example with an outlet 17.

The particularity of the present invention is that the air conduction means 7 on the one hand have been thus conceived that the air flow 6 is mainly forced to enter the drying drum 2 via an inlet, formed by the mouthpiece 14, before it can again be discharged via an outlet, formed by the mouthpiece 16. This is achieved in the illustrated example in that as shown in FIG. 5, the interspace 18 between the rotating drying drum 2 and the fixed drum 3 is reduced to a minimum, so that with the exclusion of a slight leakage stream, all air discharged via the mouthpiece 14 is forced to enter the drying drum 2, via the air passage openings 19, described hereinafter.

On the other hand, according to the invention, the air is thereby forced to enter the drying drum 2 via air passage openings which are located at the cylindrical casing part 20 of the drying drum 2 and/or are located at one axial end, in particular an axial wall part 21 of the drying drum 2, but near the outer circumference thereof. However, in the embodiment of FIGS. 1 to 5 exclusively air passage openings are used which are located at the cylindrical casing part 20, that is the above-mentioned air passage openings 19.

The air passage openings 19 are hereby located in one and the same half, that is the rear half H1 of the drying drum 2. More in particular still, they are located in a zone near the rear end 22 of the drying drum 2, which zone stretches as a band around the cylindrical casing part 20, which band has a width B that is smaller than half the axial length L of the drying drum 2 and, even more in particular, is smaller than ¼ of this length L, and better still, as shown is even less that ⅙.

The air passage openings 19 are hereby conceived in the form of a set of perforations, stretching continuously alongside the circumference and thus forming the above-mentioned band. The band formed by the air passage openings 19 is located exactly opposite the mouthpiece 14.

At the rear end 22 the drying drum 2 is closed by means of a rear wall 23, formed by the wall part 21, which is completely closed.

To discharge the air from the drying drum 2, the air conduction means 7 contain air passage openings which according to the invention are preferably located at the cylindrical casing part 20 and/or at an axial end 24 of the drying drum 2. Thereto however in the example of the FIGS. 1 to 5 exclusive use is made of air passage openings in the cylindrical casing part 20, that is the shown air passage openings 25.

These air passage openings 25 are located in the front half H2 of the drying drum 2 and are located in a zone which is close to the end 24, this in the form of a band that is stretching alongside the cylindrical casing part 20, with a width B which is preferably defined in the same way as the width B of the band, formed by the air passage openings 19.

Seen in side-view, which is also visible in the section of FIG. 5, the air inlet channel 13 and the air outlet channel 14, in particular the accompanying mouthpieces 14 and 16, are mainly located diagonally towards each other. Still in particular, the air inlet channel 13 connects to the upper half of the drum 3, respectively the drying drum 2, while the air outlet channel 15 connects to the lower half of the drum 3, respectively the drying drum 2.

Seen from a frontal view on the drying drum 2, the mouthpieces 14 and 16, and hence also the air inlet channel 13 and the air outlet channel 15, are located according to a slanting direction diagonally alongside the drum 3, which is clearly visible in FIG. 1. This positioning of the mouthpieces 14 and 16 allows for these to be mounted in the free edges of the rectangular casing part 8.

The working of the drying drum 2 can be easily derived from the Figures. By activating the means 5, air is drawn in and a hot air flow 6 is created. Due to the specific design of the air conduction means 7, including the air passage openings 19 and 25, an air stream 6 is produced which is forced to completely or almost completely go through the drying drum, whereby furthermore this air stream 6 must move through the drying drum 2 in general in a diagonal way, as shown schematically in the FIGS. 2 to 5. It has been determined that in this way an optimal drying is obtained with a minimum of energy consumption.

Although the use of a drying drum 2 with air passage openings 19 and 25 which are exclusively located in the cylindrical casing part, respectively in a band-like zone near the rear end 22 and a band-like zone near the front end 24, produces exceptional optimal results, it is clear that according to the invention, other embodiments are possible.

By way of clarification a variant is shown in FIG. 6 with air passage openings 19 and 26 to supply the air in the drying drum 2, which is respectively located in the cylindrical casing part 20 and in the rear wall 23, but near the outer circumference thereof, as well as one air passage opening 27, formed by the front end 24 of the drying drum 2, which is connected sideways to the air outlet channel 15.

FIG. 6 shows that the air passage openings 19 can also be applied alongside the complete circumference of the casing part 20.

In essence it comes down to that the air passage openings for the supply of air are all located in the zone Z1 of the drying drum 2, better still all in one zone Z2 which corresponds with the length L, better still in a zone Z3 which corresponds with the half H1, and in the most preferred embodiment exclusively in a zone Z4 which stretches along a local band around the drying drum 2.

It is also essential that a direct passage of air of the air inlet channel 13 to the air outlet channel 15 is avoided, or at least is limited to a leakage flow at the most. In the embodiment of FIG. 6 this is obtained in that the interspace exclusively leads to the drying drum 2 and is closed at its end by means of a rear wall 28.

It goes without saying that the dryer 1 according to the invention is provided with a control and operating panel, which have not been included in the drawings for the sake of simplicity. It is furthermore clear that the drying drum 2 does not necessarily have to be perfectly cylindrically. For example, at the inside thereof ribs or the like may be formed to lead the dry linen upward with the rotation of the drying drum 2. Also the outside of the drying drum 2 must not be perfectly cylindrically. When mention is made above of a cylindrical casing part, it is clear that in general is meant therewith the circumference wall of the drying drum 2 which is normally cylindrical, but around which according to the present invention also deviant designs are to be understood, which might in the end even define an angular section.

The present invention is in no way limited to the embodiments described as an example and shown in the Figures, but such drying drum can be realized in different forms and sizes, without departing from the scope of the invention.

1. A dryer, in particular a dryer to dry linen and the like, with a drying drum, drive means to rotate the drying drum, means to create an air flow, more in particular a hot air flow and air conduction means to lead the air flow through the drying drum, wherein the air conduction means have been thus conceived that the air flow is mainly forced to enter the drying drum from an inlet, before being discharged via an outlet, whereby this air thereby is also forced to enter the drying drum via one or more air passage openings which are located at the cylindrical casing part of the drying drum and/or at one axial end of the drying drum, but near the outer circumference thereof.

2. The dryer according to claim 1, wherein the above-mentioned air conduction means contain air passage openings in the drying drum to bring the air in the drying drum, and wherein all the air passage openings to bring the air in the drying drum are located at the cylindrical casing part of the drying drum.

3. The dryer according to claim 1, wherein the air conduction means contain air passage openings in the drying drum to bring the air in the drying drum, and wherein all the air passage openings to bring the air in the drying drum are mainly located in one and the same half of the drying drum.

4. The dryer according to claim 1, wherein the air passage openings which are located at the cylindrical casing part of the drying drum are located in one zone which stretches near one end of the drying drum as a band around the cylindrical casing part.

5. The dryer according to claim 4, wherein all the air passage openings to bring air in the drying drum are mainly located in the above-mentioned band-like zone.

6. The dryer according to claim 3, wherein the air passage openings to supply the air are located in the rear half of the drying drum.

7. The dryer according to claim 1, wherein the air conduction means contain at least one air inlet channel to lead the air to the drying drum, as well as at least one air outlet channel to discharge the air from the drying drum, whereby on the one hand the air inlet channel and the air outlet channel are between themselves thus arranged and on the other hand the drying drum is thus provided with air passage openings, that the air flow is in general forced to move from one end of the drying drum to the other end.

8. The dryer according to claim 1, wherein the air conduction means contain one or more air passage openings to discharge the air from the drying drum, which are located at the cylindrical casing part of the drying drum and/or at one axial end of the drying drum.

9. The dryer according to claim 8, wherein the air conduction means contain air passage openings in the drying drum to discharge the air from the drying drum, and wherein all the air passage openings to discharge air from the drying drum are located at the cylindrical casing part of the drying drum.

10. The dryer according to claim 8, wherein the air conduction means contain air passage openings in the drying drum to discharge the air from the drying drum, and wherein all the air passage openings to discharge the air from the drying drum are mainly located in one and the same half of the drying drum.

11. The dryer according to claim 8, wherein the air passage openings to discharge the air which are located at the cylindrical casing part of the drying drum, are located in a zone which stretches near one end of the drying drum as a band around the cylindrical casing part.

12. The dryer according to claim 11, wherein all the air passage openings to discharge the air from the drying drum are located in the above-mentioned zone.

13. The dryer according to claim 1, wherein the air conduction means mainly contain one air inlet channel to supply the air to the drying drum, as well as mainly one air outlet channel to discharge the air from the drying drum, whereby these connect to the drying drum, so that they have one or more of the following characteristics:
that, seen in a side-view of the drying drum, they are mainly located diagonally opposite one another;
that the air inlet channel leads to the upper half of the drying drum, while the air outlet channel connects to the bottom half of the drying drum;
that seen from a view frontal to the drying drum, they are located according to a slanting direction diagonally to one another.

14. A dryer, in particular a dryer to dry linen and the like, with a drying drum, drive means to rotate the drying drum, means to create an air flow, in particular a hot air flow, and air conduction means to lead the air flow through the drying drum, wherein the drying drum is provided with two sets of air passage openings, respectively a first set to supply the air and a second set to discharge the air, which are each located near one end of the drying drum in the cylindrical casing part and which each stretch like a band around the cylindrical casing part, whereby the part of the cylindrical casing part in between the above-mentioned two sets is generally closed.
